(19) United States
(12) Patent Application Publication
(10) Pub. No.: US 2021/0031571 A1
(43) Pub. Date: Feb. 4, 2021

(54) Central Tire Deflation/Inflation System

(71) Applicant: Polaris Industries Inc., Medina, MN (US)

(72) Inventors: Robert PFEIFFER, Aliso Viejo, CA (US); Clinton M. JOHNSON, Descanso, CA (US); Francisco RODRIGUEZ, Chula Vista, CA (US)

(21) Appl. No.: 16/934,759

(22) Filed: Jul. 21, 2020

Related U.S. Application Data
(60) Provisional application No. 62/880,848, filed on Jul. 31, 2019.

(51) Int. Cl. B60C 23/00

(52) U.S. Cl. CPC B60C 23/00345; B60C 23/00318

(57) ABSTRACT

A tire deflation and inflation system for a vehicle. The system includes a unit bearing having a plurality of wheel flanges for mounting a wheel thereto. The unit bearing is configured to receive therein a portion of an axle of the vehicle. A wheel hub is mounted to the unit bearing. An air chamber is defined by the unit bearing. In response to positive air pressure generated by an air pressure source, air flows through the air chamber to a tire of the wheel mounted to the unit bearing to increase air pressure of the tire. In response to negative air pressure generated by venting the system to atmosphere, air is drawn out of the tire through the air chamber.

### CROSS-REFERENCE TO RELATED APPLICATION

This application claims the benefit of U.S. Provisional Application No. 62/880,848, filed on Jul. 31, 2019, the entire disclosure of which is incorporated herein by reference.

### FIELD

The present disclosure relates to a central tire deflation/inflation system for a vehicle.

### BACKGROUND

This section provides background information related to the present disclosure, which is not necessarily prior art.

Air must be periodically added to, or withdrawn from, tires to keep them inflated at a desired air pressure. For example and with respect to vehicles used for off-road adventures, it may be necessary to pack and unpack cumbersome tools to change the tire pressure before, during, or after a trip. An improved system for deflating and inflating the tires would thus be desirable. The present disclosure advantageously includes a central tire inflation system that addresses these needs in the art and provides numerous additional advantages as well.

### SUMMARY

This section provides a general summary of the disclosure, and is not a comprehensive disclosure of its full scope or all of its features.

The present disclosure includes a tire inflation system for a vehicle. The system includes a unit bearing having a plurality of wheel flanges for mounting a wheel thereto. The unit bearing is configured to receive therein a portion of an axle of the vehicle. A wheel hub is mounted to the unit bearing. In response to positive air pressure generated by an air pressure source, air flows through the air chamber to a tire of the wheel mounted to the unit bearing to increase air pressure of the tire. In response to negative air pressure generated by venting the system to atmosphere, air is drawn out of the tire through the air chamber.

The present disclosure further includes a tire inflation system for a vehicle. The system has a unit bearing including a plurality of wheel flanges. The unit bearing is configured to receive therein a portion of an axle of the vehicle. A hub is mounted to the unit bearing. A sealed air chamber is defined by at least the unit bearing, the axle, and the hub. An inlet of the sealed air chamber is configured to be connected to an air pressure source. An outlet of the sealed air chamber is configured to be connected to a tire of the vehicle. Upon activation of the air pressure source to generate positive air pressure, air from the air pressure source flows through the sealed air chamber and into the tire to inflate the tire. Upon venting the system to atmosphere, air is drawn out of the tire and through the sealed air chamber.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an exemplary vehicle including a tire deflation and inflation system in accordance with the present disclosure;

FIG. 2 is a perspective view of a unit bearing, knuckle, hub, and fitting of the tire deflation and inflation system in accordance with the present disclosure for withdrawing air from, or delivering air to, a tire of the vehicle;

FIG. 3 is a cross-sectional view of FIG. 2 taken along line 3-3 of FIG. 2 with FIG. 3 further illustrating an axle of the vehicle;

FIG. 4 is an exploded view of FIG. 3;

FIG. 5 illustrates an alternative configuration of the hub and axle of FIGS. 2-4 in accordance with the present disclosure;

FIG. 6. is an exploded view of FIG. 5;

FIG. 7 is a perspective view of an additional unit bearing, knuckle, hub, and fitting of the tire deflation and inflation system in accordance with the present disclosure for withdrawing air from, or delivering air to, a tire of the vehicle;

FIG. 8 is a cross-sectional view taken along line 8-8 of FIG. 7 including an axle of the vehicle;

FIG. 9 is an exploded view of FIG. 8;

FIG. 10 is a perspective view of an additional unit bearing, axle housing, hub, and fitting of the tire deflation and inflation system in accordance with the present disclosure for withdrawing air from, or delivering air to, a tire of the vehicle;

FIG. 11. is a cross-sectional view taken along line 11-11 of FIG. 10 including an axle of the vehicle;

FIG. 12 is an exploded view of FIG. 11;

FIG. 13 illustrates an alternative configuration of the axle of FIGS. 10-12 in accordance with the present disclosure;

FIG. 14 is an exploded view of FIG. 13;

FIG. 15 is a perspective view of an additional unit bearing, axle housing, hub, and fitting of the tire deflation and inflation system in accordance with the present disclosure for withdrawing air from, or delivering air to, a tire of the vehicle;

FIG. 16 is a cross-sectional view taken along line 16-16 of FIG. 15; and

FIG. 17 is an exploded view of FIG. 16.

Corresponding reference numerals indicate corresponding parts throughout the several views of the drawings.

### DETAILED DESCRIPTION

Example embodiments will now be described more fully with reference to the accompanying drawings.

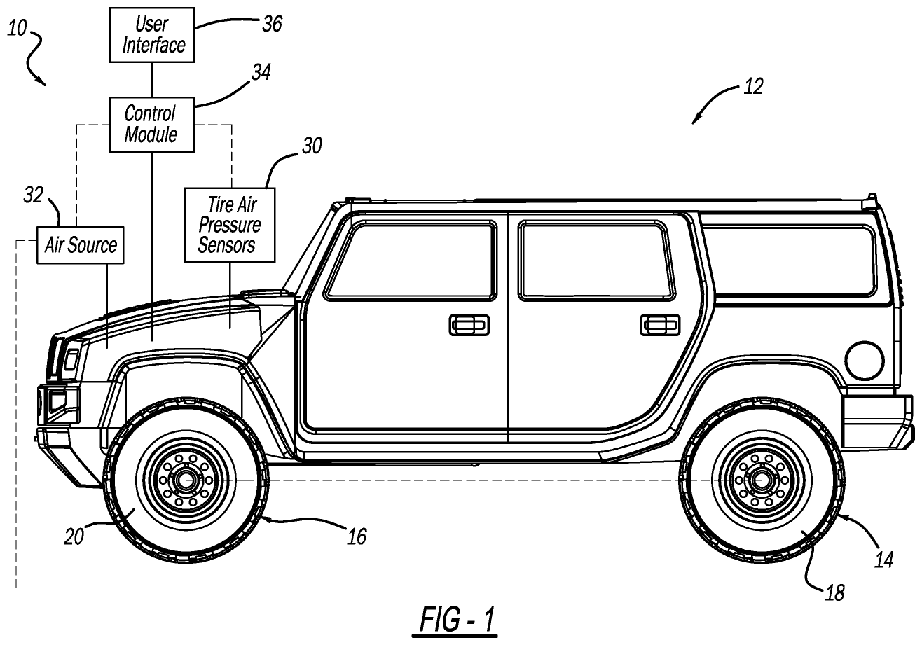

FIG. 1 illustrates a tire deflation and inflation system in accordance with the present disclosure at reference numeral 10. The tire deflation and inflation system 10 is illustrated as installed in an exemplary vehicle 12. The vehicle 12 may be any suitable vehicle, such as any suitable passenger vehicle, utility vehicle, recreational vehicle, military vehicle, construction equipment/vehicle, etc. The tire deflation and inflation system 10 may be included with the vehicle 12 when sold as new, or may be subsequently added to the vehicle 12, such as part of a retro fit.

The vehicle 12 includes a pair of rear wheels 14 and a pair of front wheels 16. The rear wheels 14 include rear tires 18, and the front wheels 16 include front tires 20. Air pressure of the tires 18, 20 is monitored by any suitable tire air pressure sensors 30.

The system 10 further includes an air pressure source 32, which is configured to generate positive pressure. The air pressure source 32 may also be configured to generate negative air pressure in the system 10 in any suitable manner, such as by venting to atmosphere. The system 10 may be vented to atmosphere in any other suitable manner as well. The air pressure source 32 may be mounted to the vehicle 12 at any suitable location and connected in fluid communication with the tires 18, 20. Negative air pressure withdraws air from one or more of the tires 18, 20 to deflate the tires 18, 20 when air pressure thereof is above a desired level, such as in preparation for operating the vehicle on off-road terrain. Positive air pressure generated by the air pressure source 32 is introduced to one or more of the tires 18, 20 to inflate the tires 18, 20 when air pressure thereof is below a desired level, such as to reflate the tires after off-roading. The air pressure source 32 may also be used to generate a vacuum to the hubs 54 of the rear or front tires 18, 20 to lock the hubs into position to provide 4x4 capability for the vehicle 12. Alternatively, the vehicle 12 may include a separate air pressure source for generating such a vacuum.

The air pressure source 32 is controlled by a control module 34, which also receives air pressure data for each of the tires 18, 20 from the tire air pressure sensors 30. In this application, including the definitions below, the term “module” may be replaced with the term “circuit.” The term “module” may refer to, be part of, or include processor hardware (shared, dedicated, or group) that executes code and memory hardware (shared, dedicated, or group) that stores code executed by the processor hardware. The code is configured to provide the features of the modules, controllers, and systems described herein. The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The system 10 further includes any suitable user interface 36, which is configured for use by a user of the vehicle 12 to input a desired air pressure for each one of the four tires 18, 20. When based on data from the tire air pressure sensors 30 the control module 34 determines that one or more of the tires 18, 20 is at an air pressure above the desired air pressure input to the control module 34 by the user at the user interface 36, the control module 34 commands the air pressure source 32 to vent to atmosphere in response to an activation command from the user to generate negative air pressure to withdraw air from one or more of the tires 18, 20 until the pressure of the tires 18, 20 decreases to the level input by the user. When based on data from the tire air pressure sensors 30 the control module 34 determines that one or more of the tires 18, 20 is at an air pressure below the desired air pressure input to the control module 34 by the user at the user interface 36, the control module 34 activates the air pressure source 32 in response to an activation command from the user to generative positive air pressure and direct airflow to one or more of the tires 18, 20 until the pressure of the tires 18, 20 increases to the level input by the user.

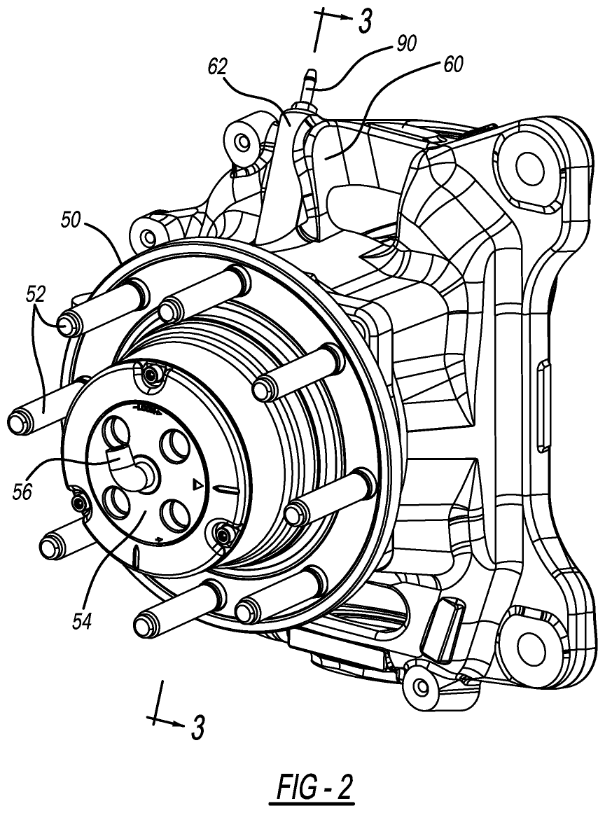

With continued reference to FIG. 1 and additional reference to FIGS. 2, 3, and 4, exemplary components of the tire inflation system 10 for connecting the air pressure source 32 to the tires 20 of the front axle (or the tires 18 of a rear axle with rear steering capabilities) will now be described. A unit bearing is illustrated at reference numeral 50. The unit bearing 50 includes a plurality of wheel flanges 52 to which either one of the front wheels 16 (or either one of the rear wheels 14 if the vehicle 12 has rear steering capabilities) is mounted to. A wheel hub is illustrated at reference numeral 54. At a center of the wheel hub 54 is a fitting 56. Negative air pressure generated when the system 10 is vented to atmosphere draws air out of the tire 20 or 18 through the fitting 56 to deflate the tire 20 or 18. Positive airflow from the air pressure source 32 flows out through the fitting 56 to the tire 20 (or the tire 18) to inflate the tire 20 or 18. The fitting 56 is thus in fluid communication with an air inlet/outlet of the tire 20 or the tire 18 in any suitable manner with any suitable air conduit. FIGS. 2, 3, and 4 further illustrate a steering knuckle 60. The steering knuckle 60 defines an air passageway 62, which is connected to the air pressure source 32 by way of a connector 90.

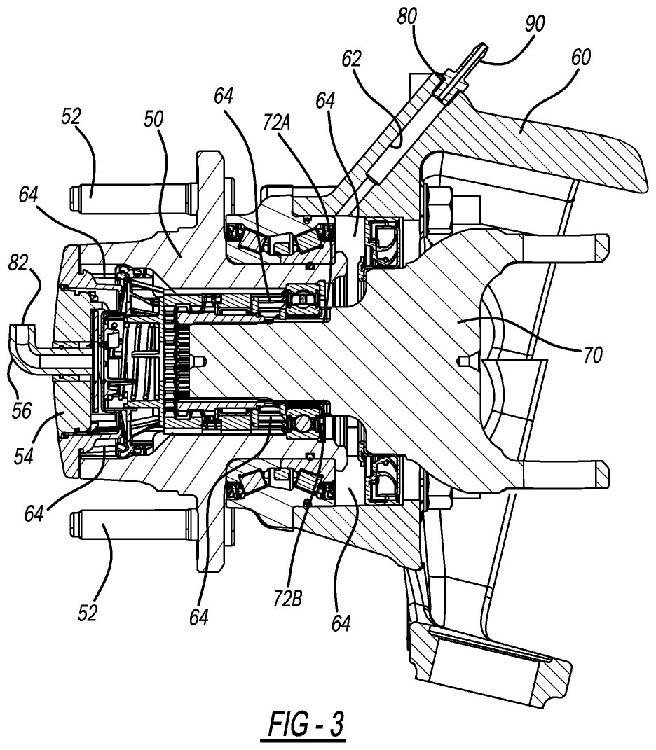

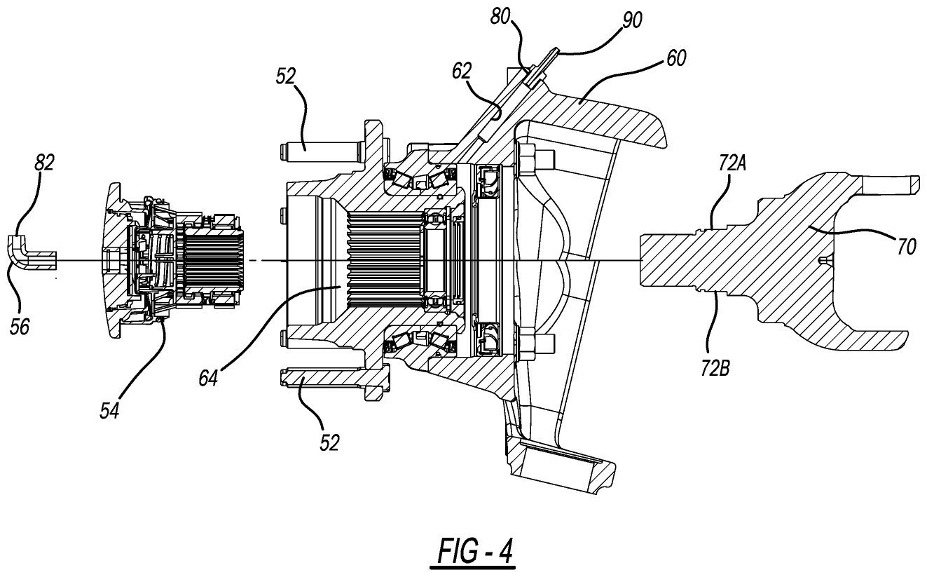

With particular reference to FIG. 3 and FIG. 4, an axle 70 (such as a stub axle) extends into the knuckle 60 and the unit bearing 50. Together the unit bearing 50, the knuckle, 60, and the axle 70 define a sealed air chamber 64. An inlet 80 of the sealed air chamber 64 is at an inlet of the air passageway 62. The connector 90 is seated in the inlet 80. The connector 90 is connected to the air pressure source 92 in any suitable manner (such as by way of any suitable air conduits) so that negative or positive air pressure generated by the air pressure source 32 enters the sealed air chamber 64 by way of the connector 90 at the inlet 80.

Specifically, airflow from the air pressure source 32 flows into the air passageway 62 and then into a portion of the sealed air chamber 64 defined by the knuckle 60. The airflow then flows across an exterior of the axle 70 through one or more grooves defined at an exterior surface of the axle 70, such as groove 72A and groove 72B (although two grooves 72A, 72B are illustrated, the axle 70 may include any suitable number of grooves spaced apart about an exterior of the axle 70). The airflow flows through the grooves 72A and 72B into a portion of the sealed air chamber 64 defined by the unit bearing 50. The airflow generated by the air pressure source 32 exits the sealed air chamber 64 through the fitting 56, which defines an outlet 82 of the sealed air chamber 64. Airflow flows in the opposite direction out of the tires when the system 10 is vented to atmosphere to generate negative air pressure to deflate the tires.

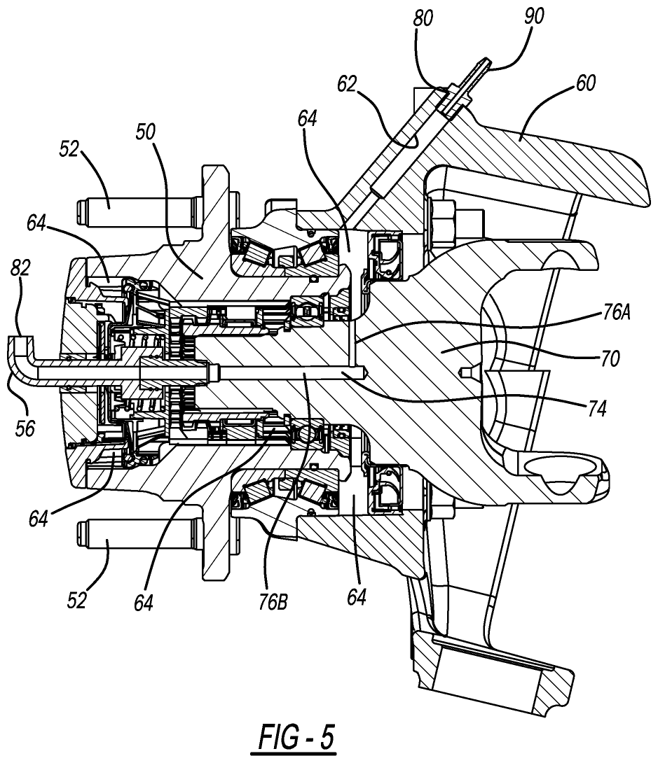

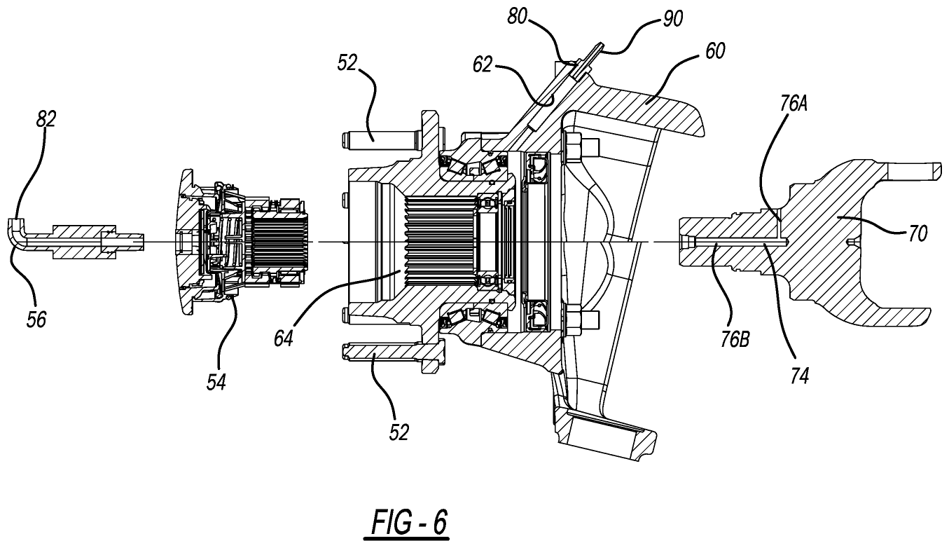

With reference to FIG. 5 and FIG. 6, the axle 70 may define an axle air passage 74, which may take the place of (or in some applications be in addition to) the grooves 72A and 72B. The axle air passage 74 includes a first portion 76A and a second portion 76B. The first portion 76A extends from an exterior surface of the axle 70 in a direction perpendicular to a rotational axis of the axle 70. The first portion 76A extends to the second portion 76B, which extends generally along the rotational axis of the axle 70. The second portion 76B extends to the fitting 56, which in the example of FIGS. 5 and 6 is a swivel fitting. Thus in the example of FIGS. 5 and 6, when the air pressure source is operated to generate positive air pressure, airflow from the air pressure source 32 enters the sealed air chamber 64 by way of the inlet 80, and flows into the first portion 76A of the axle air passage 74. From the first portion 76A, airflow from the air pressure source 32 flows to the second portion 76B and to the fitting 56, which is connected to the second portion 76B. The airflow then exits through the outlet 82 and flows to the one of the tires 20 or 18 mounted to the wheel flanges 52 by way of any suitable connection to inflate the tires. Airflow flows in the opposite direction out of the tires when the system 10 is vented to atmosphere to generate negative air pressure to deflate the tires.

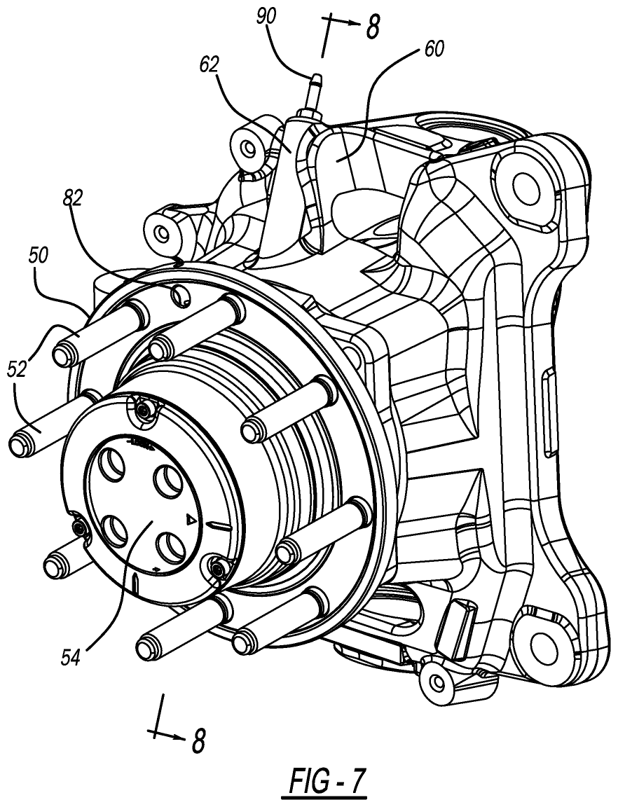

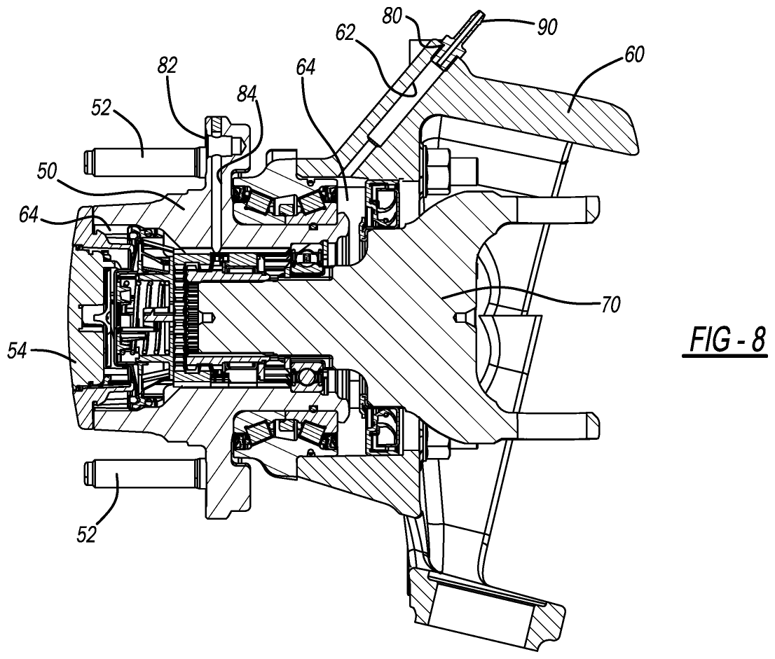

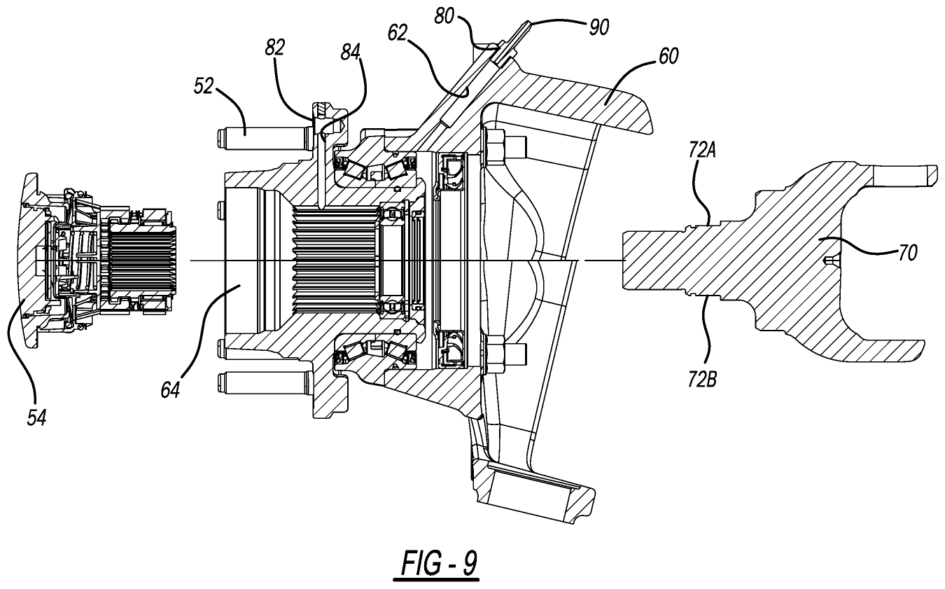

With reference to FIGS. 7, 8, and 9, the outlet 82 of the sealed air chamber 64 may be alternatively defined by the unit bearing 50 instead of at the fitting 56 attached to the hub 54. Specifically, in the example of FIGS. 7, 8, and 9, the unit bearing 50 defines an airflow passageway 84 extending from the sealed air chamber 64 to the outlet 82. From the outlet 82, the positive airflow generated by the air pressure source 32 flows to the tires 20 or 18 through any suitable connection. Airflow moves in the opposite direction when the system 10 is vented to atmosphere to generate negative air pressure. Although the example of FIGS. 7, 8, and 9 illustrates the axle 70 as defining the exterior grooves 72A and 72B, the axle 70 may include the axle air passage 74 in place of, or in addition to, the grooves 72A, 72B.

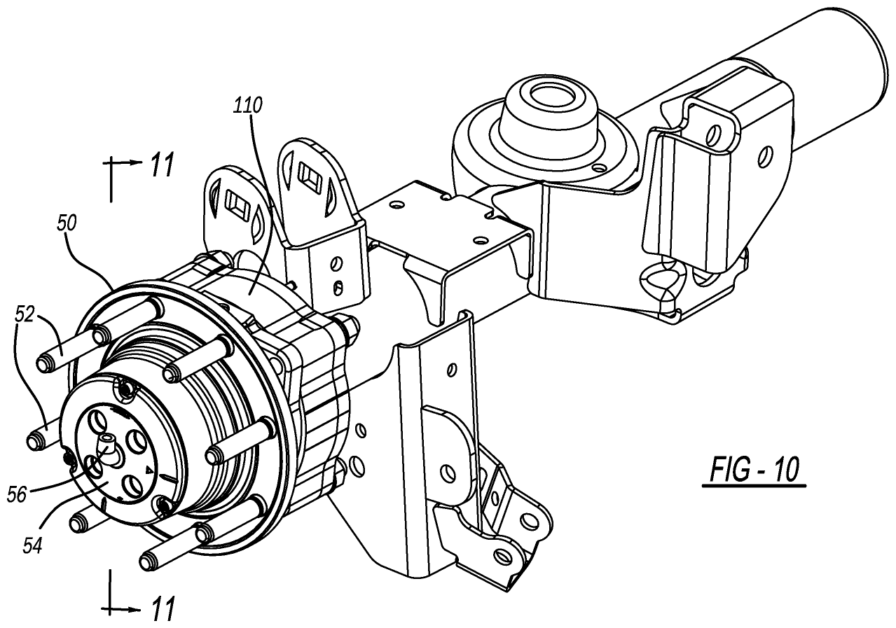

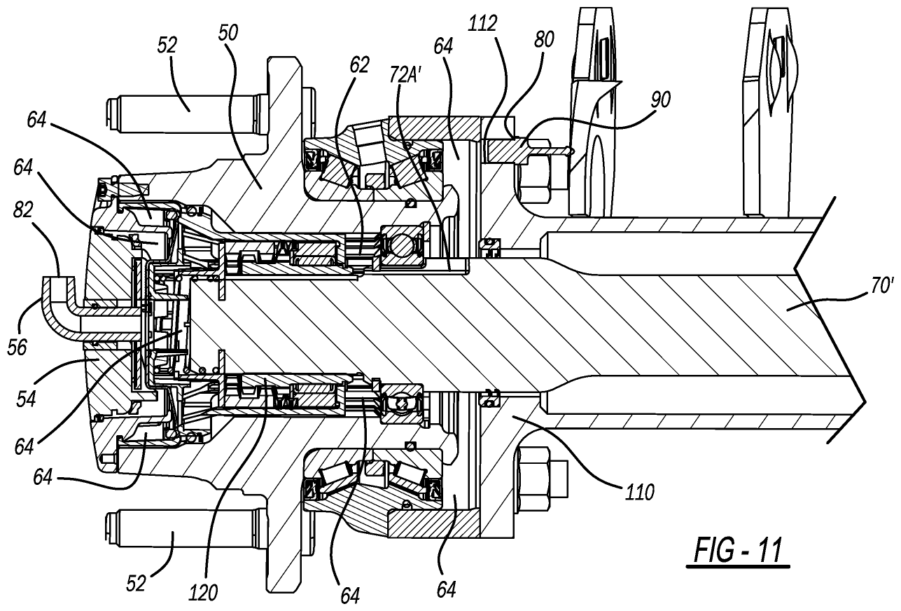

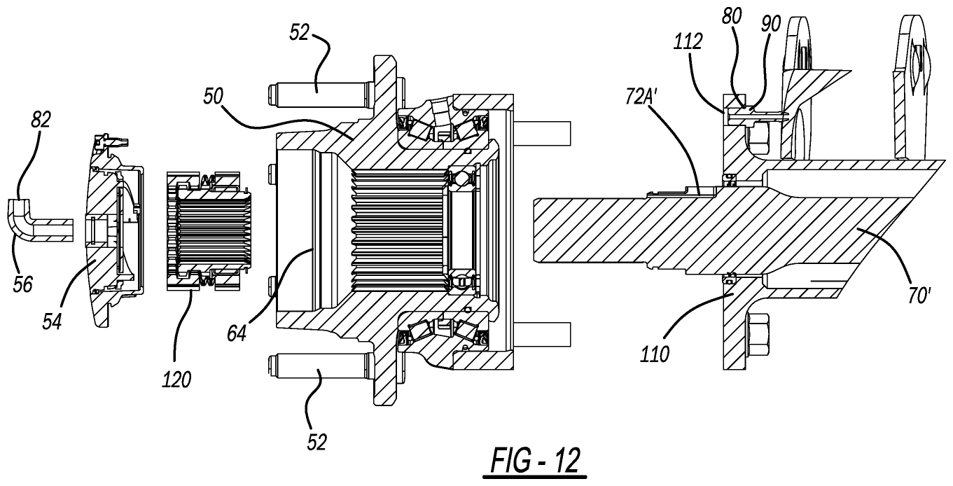

With reference to FIGS. 10, 11, and 12 in applications where the rear wheels 14 do not have rear steering capabilities, the unit bearing 50 is connected to an axle housing 110, which houses a rear axle 70′. The rear axle 70′ is seated on an axle shaft coupler 120 arranged within the unit bearing 50. The axle housing 110 defines an airflow passageway 112, which provides the inlet 80 to the sealed air chamber 64. The connector 90 is seated within the inlet 80. Thus in the example of FIGS. 10, 11, and 12, the sealed air chamber 64 is defined by the axle housing 110, the axle 70′, the unit bearing 50, and the hub 54. Airflow from the air pressure source 32 enters the sealed air chamber 64 through the inlet 80, flows from the portion of the sealed air chamber 64 defined by the axle housing 110 across the axle 70′ through one or more grooves 72A′ defined by an exterior of the axle 70′, and into the portion of the sealed air chamber 64 defined by the unit bearing 50. The airflow from the air pressure source 32 then exits the sealed air chamber 64 through the outlet 82 defined by the fitting 56 to the rear tire 18. Airflow moves in the opposite direction when the system 10 is vented to atmosphere to generate negative air pressure to deflate the tires.

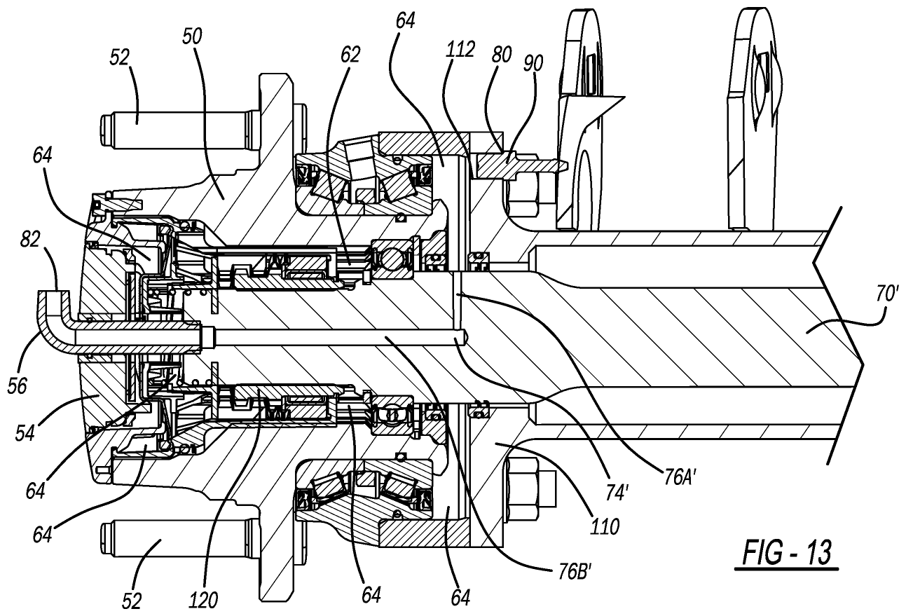

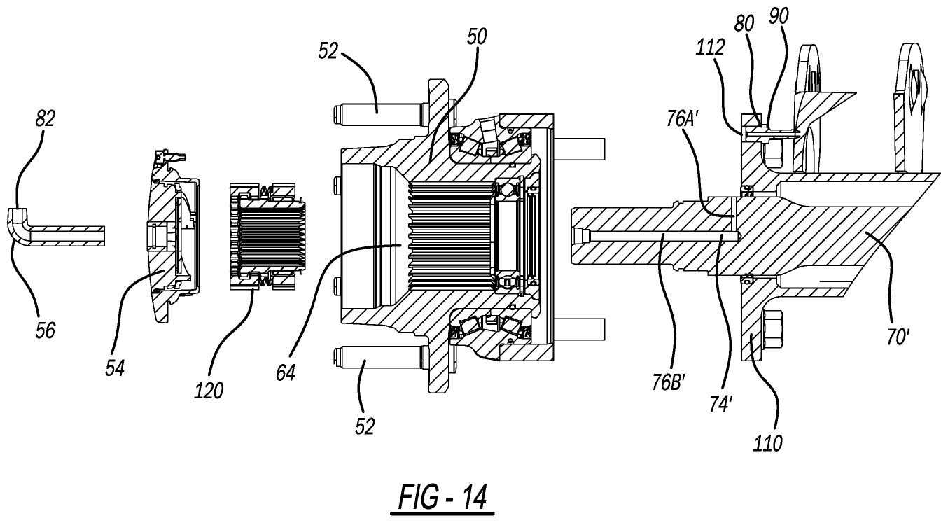

With reference to FIGS. 13 and 14, the rear axle 70′ may include axle air passage 74′. The axle air passage 74′ includes first portion 76A′ and second portion 76B′. The first portion 76A′ extends from the portion of the sealed air chamber 64 defined by the axle housing 110 to the second portion 76B′. The second portion 76B′ extends to the fitting 56. The axle air passage 74 may be in place of, or in addition to, the groove 72A′. Airflow from the air pressure source 32 within the portion of the sealed air chamber 64 defined by the axle housing 110 flows through the axle air passage 74 to the fitting 56, and exits through the outlet 82 to the tire 18. Airflow moves in the opposite direction when the system 10 is vented to atmosphere to generate negative air pressure to deflate the tires.

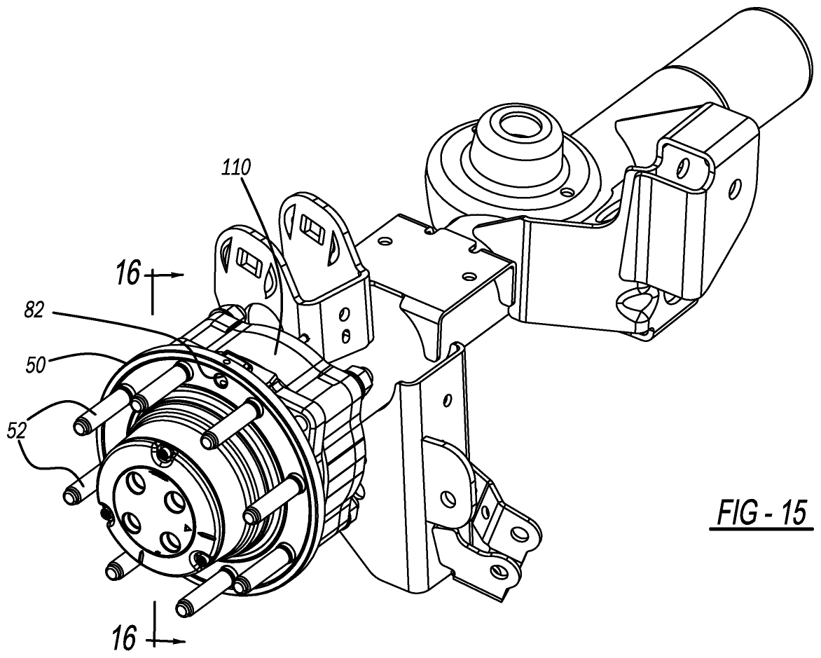

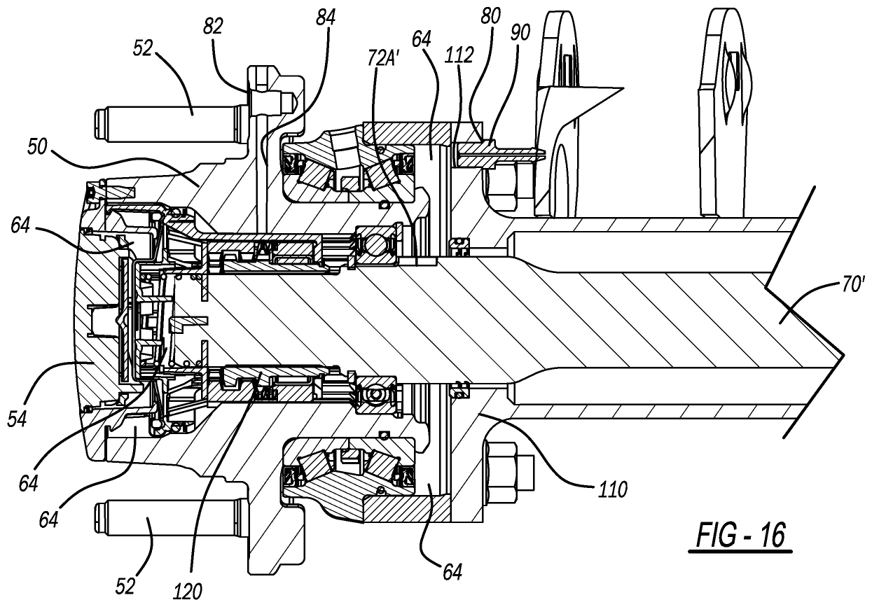

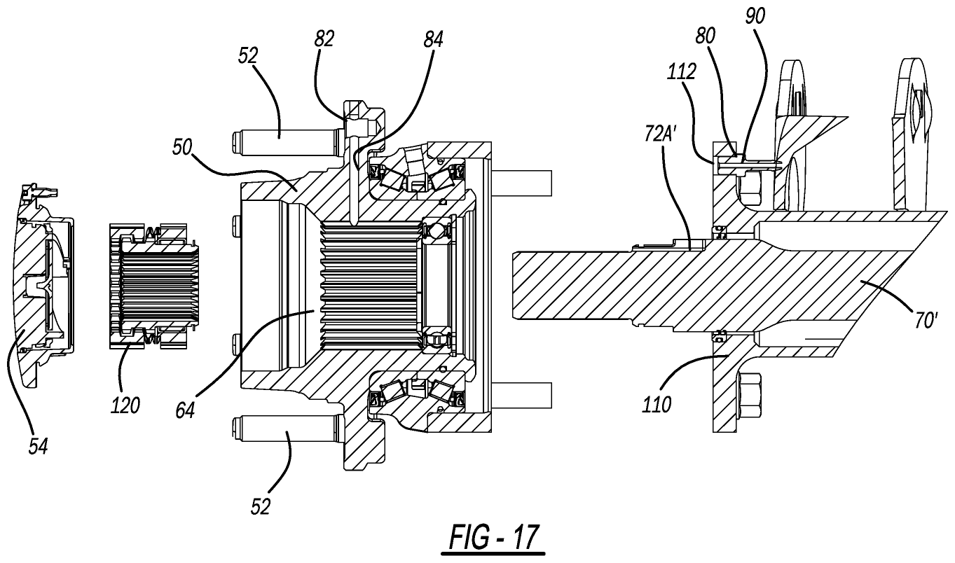

With reference to FIGS. 15, 16, and 17, in applications including the axle housing 110, the unit bearing 50 may define the outlet 82 of the sealed air chamber 64 at an exterior of the unit bearing 50. The unit bearing 50 further defines the passageway 84 extending from the outlet 82 to the sealed air chamber 64. Although the configuration of FIGS. 15, 16, and 17 illustrates the rear axle 70′ as defining the groove 72A′ at the exterior thereof, the configuration of FIGS. 15, 16, and 17 may alternatively include the axle air passage 74′.

The present disclosure thus advantageously provides for a tire deflation and inflation system 10 that allows a user to input a desired air pressure for the tires 18, 20 by way of the user interface 36. When the control module 34 determines that the air pressure of the tires 18, 20 falls below the air pressure input by the user based on inputs from the tire air pressure sensors 30, the control module 34 activates the air pressure source 32 in response to a user input to generate positive air pressure to one or more of the tires 18, 20 that has fallen below the set air pressure. The air enters the sealed air chamber 64 through the inlet 80 by way of any suitable airflow connection between the air pressure source 32 and the inlet 80 associated with the particular one of the rear tires 18 or front tires 20 in need of additional air pressure. The airflow exits the sealed air chamber 64 through the outlet 82 to the tire 18, 20 by way of any suitable air line to increase the air pressure of the particular tire 18, 20 to the set air pressure. When the control module 34 determines that the air pressure of the tires 18, 20 is above the air pressure input by the user based on inputs from the tire air pressure sensors 30, the control module 34 activates the air pressure source 32 to generate negative air pressure (such as by venting to atmosphere) to withdraw air from one or more of the tires 18, 20 that is above the set tire pressure. Thus the tire inflation system 10 eliminates the need for a user to pack and unpack cumbersome tools required to manually deflate and/or inflate each one of the tires 18, 20 individually. One skilled in the art will appreciate that the tire deflation and inflation system 10 provides numerous additional advantages as well.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A tire deflation and inflation system for a vehicle, the system comprising:
a unit bearing including a plurality of wheel flanges for mounting a wheel thereto, the unit bearing configured to receive therein a portion of an axle of the vehicle;
a wheel hub mounted to the unit bearing; and
an air chamber defined by the unit bearing, in response to positive air pressure generated by an air pressure source air flows through the air chamber to a tire of the wheel mounted to the unit bearing to increase air pressure of the tire, and in response to negative air pressure generated by venting the system to atmosphere air is drawn out of the tire through the air chamber.

2. The tire deflation and inflation system of claim 1, further comprising:
a tire air pressure monitor configured to monitor air pressure of the tire; and
a control module in receipt of air pressure data from the tire air pressure monitor and configured to operate the air pressure source to generate positive air pressure or vent to atmosphere;
wherein in response to an input from a user including a requested air pressure, the control module:
activates the air pressure source to generate positive air pressure and move air through the air chamber to the tire to inflate the tire until the air pressure of the tire reaches the requested air pressure as measured by the tire air pressure monitor; or
activate the air pressure source to vent to atmosphere to draw air out of the tire and through the air chamber to deflate the tire until the air pressure of the tire reaches the requested air pressure as measured by the tire air pressure monitor.

3. The tire deflation and inflation system of claim 1, further comprising a steering knuckle coupled to the unit bearing, the air chamber is further defined by the knuckle, and the knuckle defines a passageway therethrough defining an inlet to the air chamber.

4. The tire deflation and inflation system of claim 1, further comprising an axle housing coupled to the unit bearing, the air chamber is further defined by the axle housing, and the axle housing defines a passageway therethrough defining an inlet to the air chamber.

5. The tire deflation and inflation system of claim 1, wherein the unit bearing defines an outlet of the air chamber.

6. The tire deflation and inflation system of claim 1, wherein the axle shaft defines at least one groove at an external surface thereof through which airflow generated by the air pressure source enters the unit bearing, and through which airflow drawn out of the tire by negative pressure flows.

7. The tire deflation and inflation system of claim 1, wherein the axle defines an air passage extending through an interior of the axle through which airflow generated by the air pressure source enters the unit bearing, and through which airflow drawn out of the tire by negative pressure flows.

8. The tire deflation and inflation system of claim 1, further comprising a fitting extending from an exterior of the hub, the fitting arranged at an outlet of the sealed air chamber and in fluid communication with the tire to direct air into the tire when the air pressure source generates positive pressure, and direct air out of the tire when the system is vented to atmosphere.

9. A tire deflation and inflation system for a vehicle, the system comprising:
a unit bearing including a plurality of wheel flanges, the unit bearing configured to receive therein a portion of an axle of the vehicle;
a hub mounted to the unit bearing; and
a sealed air chamber defined by at least the unit bearing, the axle, and the hub, an inlet of the sealed air chamber is configured to be connected to an air pressure source, and an outlet of the sealed air chamber is configured to be connected to a tire of the vehicle;
wherein upon activation of the air pressure source to generate positive air pressure, air from the air pressure source flows through the sealed air chamber and into the tire to inflate the tire; and
wherein upon venting the system to atmosphere air is drawn out of the tire and through the sealed air chamber.

10. The tire deflation and inflation system of claim 9, further comprising a steering knuckle coupled to the unit bearing, the steering knuckle further defining the sealed air chamber.

11. The tire deflation and inflation system of claim 10, wherein the steering knuckle defines an air passage therethrough, the inlet of the sealed chamber is at an inlet of the air passage such that air from the air pressure source enters the sealed air chamber through the inlet of the air passage defined by the steering knuckle.

12. The tire deflation and inflation system of claim 9, further comprising a fitting extending from an exterior of the hub, the fitting arranged at the outlet of the sealed air chamber and in fluid communication with the tire to direct airflow out of or into the tire.

13. The tire deflation and inflation system of claim 9, wherein the axle is a stub axle.

14. The tire deflation and inflation system of claim 13, wherein the hub is seated on the stub axle.

15. The tire deflation and inflation system of claim 9, wherein an exterior groove of the axle and an interior of the unit bearing define an air passage therebetween to permit airflow from the inlet into a portion of the sealed air chamber defined by the unit bearing.

16. The tire deflation and inflation system of claim 9, wherein:
a portion of the sealed air chamber defined by the axle is an axle air passage extending through an interior of the axle; and
an air fitting is connected to an outlet of the axle air passage, the air fitting extends through the hub and is connectable to the tire to deliver air from the air pressure source to the tire.

17. The tire deflation and inflation system of claim 9, wherein the outlet of the sealed air chamber is defined by the unit bearing.

18. The tire inflation system of claim 9, further comprising an axle housing coupled to the unit bearing, the axle housing further defining the sealed air chamber.

19. The tire deflation and inflation system of claim 18, wherein the axle housing defines the inlet to the sealed chamber.

20. The tire deflation and inflation system of claim 9, further comprising an axle shaft coupler mounted to the axle within the unit bearing.
